(19) United States
(12) Patent Application Publication
(10) Pub. No.: US 2007/0235222 A1
(43) Pub. Date: Oct. 11, 2007

(54) Cable management unit

(76) Inventor: Robert A. Hubbard, Coto de Caza, CA (US)

Correspondence Address: MICHAEL A. SHIPPEY, PH. D., LAW OFFICES OF KARLA SHIPPEY, 4848 LAKEVIEW AVENUE, SUITE E, YORBA LINDA, CA, 92886, US

(21) Appl. No.: 11/786,063

(22) Filed: Apr. 9, 2007

Related U.S. Application Data
(60) Provisional application No. 60/744,445, filed on Apr. 7, 2006.

(51) Int. Cl. H02B 1/40

(52) U.S. Cl. 174/480

(57) ABSTRACT

A cable organizer box for the maintenance of cables connecting computer workstations and peripherals, including power supplies, is described. The system comprises a specially adapted box that attaches via a removable top surface to the underside of a table or desk. The box has a hinged wall that opens easily for the insertion of wires, cables, and the like. The hinged wall can then be secured in the closed position. The box is easily installed and removed, and is reusable at a new location.

### CROSS-REFERENCE TO RELATED APPLICATION

The present application is related to and claims priority from prior provisional application Ser. No. 60/744,445, filed Apr. 07, 2006, the content of which is incorporated herein and is not admitted to be prior art with respect to the present invention by the mention in this cross-reference section.

### BACKGROUND

This invention relates to providing a means for removing the clutter of computer and peripheral cables that tend to accumulate under the desks at workstations.

Personal computers and workstations are ubiquitous in the working office today. Due to the massive increase in technology, individual workstations now are connected to a wide range of peripherals, such as monitors, printers, PDAs, servers, and many others. Even a small office of fewer than 10 persons will have several of these workstations with associated peripherals.

Clearly, a need exists for improved control of this massive outpouring of haphazardly located and arrayed computer and peripheral cables.

### PRIOR WORK IN THE AREA OF THE INVENTION

No prior art has been found that is admitted or known to read on the current invention. However, as is always the case, there are related devices known, that pertain to the current invention.

Inventor Baker depicts a computer servicing cart, comprising one or more battery servicing compartments or modules for charging and storing batteries for electronic devices. This is noted in U.S. Pat. No. 7,130,190, a recent patent that issued on Oct. 31, 2006.

C. M. Hoi and C. J. Lee are inventors of a cable organizer for ease of managing cables. The organizer consists of a holding sleeve and a cable guide. It is described in U.S. Pat. No. 6,809,266, which issued on Oct. 26, 2004.

Inventor Andrew Kopish describes a cabinet for housing a computer workstation. The cabinet includes a folding table or desk with a table top, a pair of spaced apart legs, and a wire management structure pivotably mounted between the legs. This is revealed in U.S. Pat. No. 6,589,308, which issued on Jul. 8, 2003.

David Bolognia et al are the inventors of a cable organizer assigned to Compaq Computer. The invention consists of a rack-mounted tensioner with extensible member, for retaining and reeling in loose cables. Their invention fills the pages of U.S. Pat. No. 6,407,933, of issue date Jun. 18, 2002.

Michael Joseph et al are the inventors of a cable organizer as described in U.S. Pat. No. 5,954,301, which has issued date of Sep. 21, 1999. Their invention includes a clamp/cable organizer with a tray and several mounting ears.

### OBJECTS AND FEATURES OF THE INVENTION

A primary object and feature of the present invention is to overcome the above-described problems.

Another primary object and feature of the present invention is to provide a cable organizer box that can be installed by laymen, or unskilled labor.

It is a further object and feature of the present invention to provide such a system that prevents or avoids computer cables being accidentally kicked. This common occurrence leads to cables being pulled out of computers or peripherals. In some instances, this leads to loss of data and waste of workers time.

It is another object and feature of the present invention to provide such a system that is simple, easily useable, and readily available.

It is a further object and feature of the present invention to provide an improved system for the organization of cluttered cables and wires.

A further primary object and feature of the present invention is to provide such a system that is efficient, inexpensive, and handy. Other objects and features of this invention will become apparent with reference to the following descriptions.

### SUMMARY OF THE INVENTION

In accordance with a preferred embodiment hereof, this invention provides a system related to handling of cables and wires used in office workstations.

A cable organizer box for the maintenance of cables connecting computer workstations and peripherals, including power supplies, is described. The system comprises a specially adapted box that attaches via a removable top surface to the underside of a table or desk. The box has a hinged wall that opens easily for the insertion of wires, cables, and the like. The hinged wall can then be secured in the closed position. The box is easily installed and removed, and is reusable at a new location.

Also, the present invention provides such a system wherein wires are removed from under foot, and thus, to a large degree, kicking of wires is avoided. This in turn leads to fewer unwanted events, including trips and falls, or pulling cables and causing their disconnection from power sources or computers, which event can lead to loss of sensitive or valuable data.

Moreover, it provides each and every novel feature, element, combination, step and/or method disclosed or suggested by this provisional patent application.

### BRIEF DESCRIPTION OF THE DRAWINGS

The drawings form a part of the technical description of the current invention. They are therefore to be interpreted, in conjunction with the written description as further supporting the claims as set for the current invention. The drawings set forth a preferred embodiment of the current invention, and are not to be seen as limiting the scope of the invention as described herein.

FIG. 1 shows a frontal view illustrating a cable organizer box of the current invention, in open position, installed below the surface of a table, according to a preferred embodiment of the present invention. The table itself, and the wires and connector strip located within the box, form no part of the current invention, and are included for illustrative purposes only.

FIG. 2 illustrates a perspective view of the cable organizer box of FIG. 1 in a closed position according to a preferred embodiment of the present invention.

FIG. 3 displays a view from above of the box of FIG. 2, in partial cutaway section, illustrating the access apertures and hinges in the bottom wall of the cable organizer box, according to the preferred embodiment of FIG. 1.

FIG. 4 shows a perspective view illustrating preferred external features of the cable organizer box, including the removal of the top wall, and the extension of the hinged side wall, according to the preferred embodiment of FIG. 1.

### DETAILED DESCRIPTION OF THE BEST MODES AND PREFERRED EMBODIMENTS OF THE INVENTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as representative basis for teaching one skilled in the art to employ the present invention in virtually any appropriately detailed system, structure or manner.

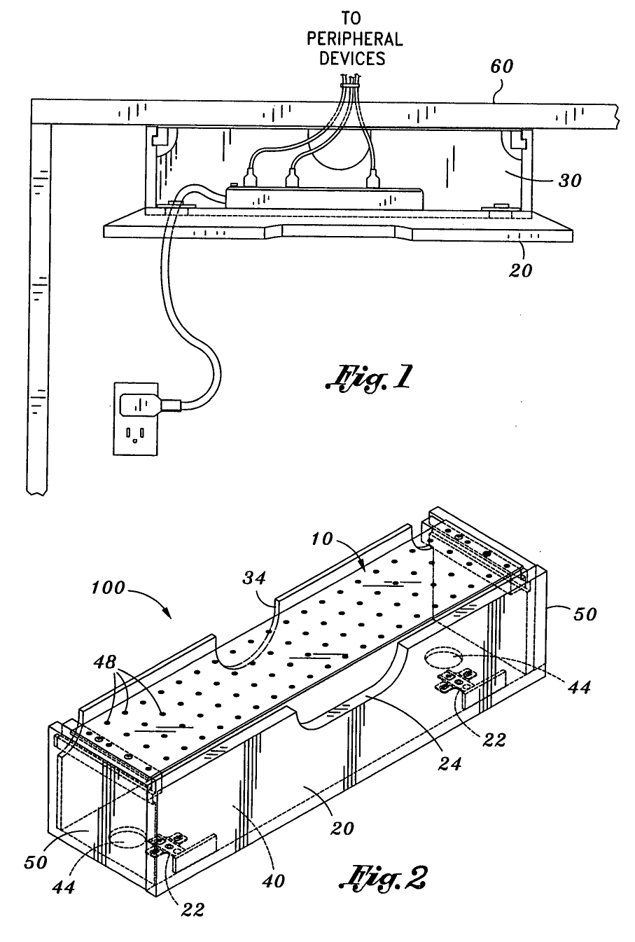

FIG. 1 shows a frontal view, in installed condition, illustrating the current invention 100 installed underneath a work table 60 according to a preferred embodiment of the present invention. The hinged wall 20 is shown in the open position, for better illustration of typical contents of the box of the current invention. In this particular example, a multitude of power cables are plugged into an outlet box, perhaps a surge protector unit. By this use of the current invention, instead of the multitude of cables crossing the floor to a distant wall outlet or surge protector, only one cable—the power cable of the outlet box itself—remains on the floor. All of the other cables are raised out of the way of foot traffic. The result is a safer and more efficient workstation.

The work table, cables, and outlet box inside the current invention themselves form no part of the current invention, and are presented for illustrative purposes only.

Note that the box comprising the current invention, and the contents therein on any particular occasion, may constitute a fairly heavy assembly. This imposes certain requirements on the materials and methods used in the current invention. The box must be reasonably sturdy to withstand the weight of the box and contents, so that it does not collapse under its own weight. We have found that a box constructed principally of wood or plywood of at least ¼ inch thickness provides sufficient durability. Also of concern are the means for attachment of the top wall to the side walls, and the top wall to the supporting body. In FIG. 1, the supporting body is table 60, while the top wall is obscured against the underside of the table. The means for attachment of the top wall will be illustrated in later figures.

The single power cord leading from the wall electrical socket to the box enters the box via an aperture in the bottom wall. The cables rising to meet the peripheral devices exit the box via an aperture in the back wall 30. These apertures can be better seen in later figures.

FIG. 2 shows a perspective view of the box 100 of the current invention, dismounted and in closed position, according to a preferred embodiment of the present invention. The identified elements of the invention in this figure include the removable top wall 10, the drop-down hinged wall 20, the bottom wall 40, and the end walls 50.

As seen in FIG. 1, a principal feature of the top wall 10 is to connect the box to a supporting body, such as the underside of a table or desk. A principal characteristic of hinged wall 20 is its ability to drop down, thereby opening up the box, and thus admitting cables and wires.

A second important feature of hinged wall 20 is its ability to remain in either the horizontal open position as illustrated in FIG. 1, or the vertical closed position of FIG. 2. There are several means to accomplish these desired goals. For instance, we could allow the force of gravity alone to hold the wall in its open position, and perhaps install a magnetic latch, or even a physical latch, at the top of wall 20 in order to keep it in closed vertical position when desired. However, we have installed in a preferred embodiment of the current invention self-locking hinges 22. These hinges act in concert to hold the wall 20 in closed vertical position. When a small amount of force is applied, by hand, to open the box—typically by using the hand hold cutout at 24—the hinges release the wall 20, allowing it to drop down to horizontal position. Hinges 22 then hold the wall 20 in substantially horizontal position, not allowing it to drop further. The user simply closes the door by using handle element 24 to grab the wall and swing it into the closed, vertical position. This type of locking hinge is well known in the art, and is widely used in residential cabinets.

Upon reading the teachings of this specification, those of ordinary skill in the art will now understand that, under appropriate circumstances, considering such issues as intended use, cost, nature and box material, etc., other attachment arrangements, such as, for example, latches, “tensionable” bands, cord ties, “bungee” cords, hooks with corresponding eyelets, cohesive surfaces, adhesive-backed tapes, elastic bands, surface bonded to the wall, hook and loop bands, and the like, may suffice to hold wall 20 in substantially vertical position. Furthermore, any type of hinge, or some other means of flexible connection as known in the art, of wall 20 to wall 40 or any adjacent wall, is contemplated in the current invention.

Still referring to FIG. 2, additional features shown include apertures 44 and 48. The larger apertures 44 are important, for they admit the cables or wires which are being organized inside the box 100 of the current invention. For example, the lower power cable in FIG. 1 that leads from the wall electrical socket to the strip outlet passes through an aperture 44, although the aperture is end on and thus not as readily visible in this figure as it is in FIG. 2.

Also visible in FIG. 2 are a plurality of small apertures 48. These are useful as ventilation for the box, since (especially with a strip outlet inside the box) heat can be generated by the components stored within the box. However, ventilation can be accomplished in other ways, for instance by adding more large apertures 24 or 44, by creating gaps between the various walls, by adding a fan, or by any other cooling means known in the art.

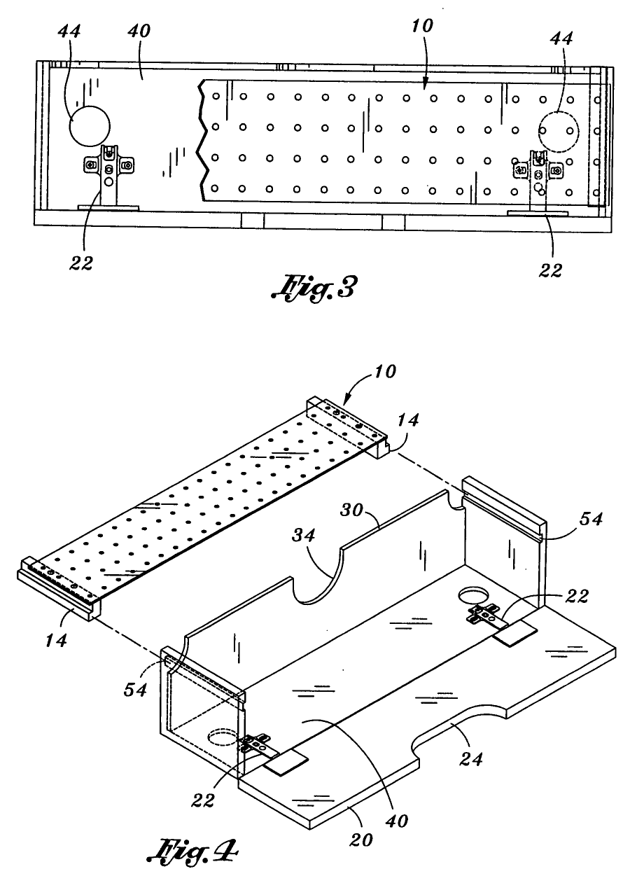

FIG. 3 demonstrates the current invention in closed position in a view from the top, according to a preferred embodiment of the present invention. The top wall 10 is partially cut away to reveal details in the bottom of the box. The details include bottom wall 40. and pairs of apertures 44. Also present is the pair of hinges 22 that enable the hinged wall to drop down, and open the box.

Now referring to FIG. 4, the current invention is illustrated in fully open position in a perspective view, according to a preferred embodiment of the present invention. The top wall 10 is removed in this view, and the hinged wall 20 is shown in open position. The handle aperture 24 is shown at the edge of hinged wall 20, and the cable exit aperture 34 is shown at the top of back wall 30.

Top wall 10 is shown via dashed lines to be slidably engaged to end walls 50. In a preferred embodiment of the current invention, this is accomplished by a pair of rails 14, mounted at each end of top wall 10 as shown. The rails 14 mate to channels 54 near the top of each end wall 50. The top wall slides in place with rails 14 engaging channels 54. The box is then suspended and held by said engagement, as top wall 10 is mounted to a desk, table, or other body.

The preferred method of mounting top wall 10 to the underside of a body is via screws. To this end, screw holes 12 are located at locations along the rail ends of wall 10. The wall 10 can thus be secured to the underside of a table, as demonstrated in FIG. 1.

Upon reading the teachings of this specification, those of ordinary skill in the art will now understand that, under appropriate circumstances, considering such issues as intended use, other attachment arrangements, such as, for example, using glue, nails, paste, hook and loop fabric, hooks with corresponding eyelets, elastic connectors, or other connectors as known in the art may suffice to fasten the top wall to any appropriate surface.

The current invention thus contemplates a first method of installing the current invention in a location suitable for its purpose of organizing cables, and a second method for actual use of the current invention in the organization of cables. These methods will now be described in their preferred embodiments, with the understanding that other methods may be used consistent with the spirit and teachings of the current invention.

Methodology

The first method of installing the current invention in the preferred embodiment is the following:

Screws are placed in screw holes 12 of top wall 10, preferably in sequential rather than concurrent fashion. In similar sequential fashion, the screws are driven into a support body, such as the underside of a table surface 60, as displayed in FIG. 1. When applying these screws, care must be taken to attach the top wall 10 in such a manner that rails 14 are left exposed, in order to connect the rest of the box of the current invention. Once the screws have all been engaged, the box is slidably engaged to the top wall, by sliding the channels 54 of the box onto the rails 14 of the top. This sliding engagement is demonstrated in FIG. 4.

The second method indicates the method of use of the box of the current invention. This method can be applied either to a free-standing box, or to a box previously installed as per the first method. Also, the box can be installed or oriented in any direction. Normally, the pre-installation method is preferred, in a level position underneath an elevated surface such as a table.

The second method in the preferred embodiment of the current invention is the following: First, the box is slidably engaged with the top wall 10, after said top wall has been attached to a support surface. Then, the hinged door 20 is opened, as seen in FIGS. 1 and 4. Next, cables are admitted to the box, either via apertures 44, or through cutout 34. Note that it may be necessary to disconnect cables from at least one terminal each, prior to admission into the box.

Normally, cables should be both entering and exiting the box by one of these larger apertures. However, as seen in FIG. 1, the number of entering cables does not always equal the number of exiting cables.

Finally, the hinged door 20 is closed by returning it to the upright position. At this time, cables can be reconnected and used normally.

The current invention can be removed from an installed location, and re-used. In the preferred embodiment of the current invention, removal is attained by the reverse of the installation procedure. Thus, first the hinged wall 20 is opened, and the contents of the box removed. Next, the box is slidably disengaged from the top wall 10. Finally, the screws in screw holes 12 are unscrewed and removed. Then top wall 10 is removed, and if desired, can be reinstalled in a new location. Alternatively, top wall 10 can be slidably reattached to the box, and the entire unit stored or used as a free-standing unit.

Note that the present invention can work with any type of elongated lead, and is not solely dedicated to use with power cords and computer cables. For instance, telephone wires, stereo cables, appliance power cords, and any loose leads can be organized and removed from foot traffic with the current invention.

Although applicant has described applicant's preferred embodiments of this invention, it will be understood that the broadest scope of this invention includes modifications such as diverse shapes, sizes, and materials. Such scope is limited only by the below claims as read in connection with the above specification. Further, many other advantages of applicant's invention will be apparent to those skilled in the art from the above descriptions and the attached claims.

What is claimed is:

1. A cable management unit comprising:
a housing, comprising side walls and a bottom wall; and
a removable top wall;
wherein the top wall is attachable to a surface of a body; and,
wherein at least one said wall contains at least one aperture capable of admitting at least one cable.

2. The cable management unit according to claim 1, wherein said top wall further comprises a plurality of support rails.

3. A cable management unit according to claim 2, further comprising channels for receiving the support rails of the top wall.

4. The cable management unit according to claim 1 wherein at least one said side wall is hingeably connected to the bottom wall.

5. The cable management unit according to claim 4, wherein said hingeably connected side wall further comprises handle means enabling a person to open and close said wall.

6. The cable management unit according to claim 1, wherein said top wall further comprises apertures for the engagement of screws.

7. The cable management unit according to claim 1, wherein said top wall is attachable to the underside of a planar body.

8. The cable management unit according to claim 1, wherein said top wall is attachable by screw means to said planar body.

9. The cable management unit according to claim 5 wherein said hingeably connected side wall extends from a substantially vertical position when closed to a substantially horizontal position when open.

10. The cable management unit according to claim 5, wherein said housing comprises latching means for retaining said hingeably connected side wall in a closed condition.

11. The cable management unit according to claim 1, wherein said housing comprises a plurality of apertures.

12. A method of installing the cable management unit of claim 1, the method comprising:
sliding the top wall of the unit out of the unit;
attaching the top wall to a surface, preferably with screw means; and,
sliding the unit back onto the top wall, with the hinged wall exposed.

13. A method of cable management comprising:
sliding the top wall of the unit out of the unit;
attaching the top wall to a surface, preferably with screw means;
sliding the unit back onto the top wall, with the hinged wall exposed;
opening said hinged wall;
placing electrical cables into the box, allowing each end of each cable to extend out of the box to reach its destination; and,
closing the hinged wall.

14. A cable management unit comprising:
a housing, comprising four side walls and a bottom wall; and
a removable top wall;
wherein the top wall is attachable to a surface of a body; and,
wherein at least one side wall is hingeably attached along one edge; and,
wherein at least one side wall contains at least one aperture capable of admitting at least one electrical cable.
